(19) United States
(12) Patent Application Publication
(10) Pub. No.: US 2010/0323729 A1
(43) Pub. Date: Dec. 23, 2010

(54) ELECTRONIC CARD PRESENTATION AND EXCHANGE

(76) Inventors: Carrie Chitsey, Cedar Park, TX (US); Michael Sattler, Cedar Park, TX (US)

Correspondence Address: DUBOIS, BRYANT, CAMPBELL & SCHWARTZ, LLP, 700 LAVACA STREET, SUITE 1300, AUSTIN, TX, 78701, US

(21) Appl. No.: 12/818,097

(22) Filed: Jun. 17, 2010

Related U.S. Application Data
(60) Provisional application No. 61/187,933, filed on Jun. 17, 2009.

(51) Int. Cl. H04W 4/12

(52) U.S. Cl. 455/466

(57) ABSTRACT

An information distribution and management system is disclosed. The information distribution and management system includes method and system for presenting and distributing electronic business cards. Once a user is registered, provides contact information to a database, and designates which of the contact information to include in the user's contact profile, the user can instruct the system to send an email to a third party upon request. Alternatively, a third party can request and receive the user's contact profile upon request. In certain embodiments, a keyword may be used to restrict access to the user's contact profile.

### PRIORITY STATEMENT UNDER 35 U.S.C. §119 & 37 C.F.R. §1.78

This non-provisional application claims priority based upon prior U.S. Provisional Patent Application Ser. No. 61/187,933 filed Jun. 17, 2009 in the name of Carrie Chistey Hice and Michael Sattler entitled “Electronic Card Presentation and Exchange by Mobile Phone,” the disclosure of which is incorporated herein in its entirety by reference.

### BACKGROUND OF THE INVENTION

It is very common today for individuals to distribute or exchange business cards. Normally, the distribution or exchange of business cards occurs during the course of business; however, such distributions or exchanges can also occur in more personal settings.

The utilization of wireless communication devices such as cell phones, mobile phones and similar communication devices is becoming increasingly popular in today's wireless environment. For example, cellular phone service is used for both business and personal purposes through standard wireless communication providers such as Sprint or AT&T.

The popularity of wireless communication devices has led to growing desire for improvements in available features (both hardware and software) for user satisfaction. The major improvements have included the creation of lightweight devices and inclusion of advanced features, such as web access, call waiting, caller ID, time display, and the like. Some of these features are provided as a menu option that may be enabled or disabled by the user.

The convenience of utilizing wireless communication devices to conduct business, particularly when the user is outside of a “traditional” office setting is very important reason for the fast expansion of cellular phone use. An individual is able to keep in touch with his office and with other business contacts—old and new—while outside of his office.

Typically, when a new contact is made, either business or personal, the preferred method of providing business contact information is with a business card. When a person desires to give a customer or client a business card, the card must be physically presented to the recipient. Providing a potential customer or client with a business card allows the business person to establish a “foothold” with a customer in a professional manner.

In today's global business environment, with the wide proliferation of wireless communication devices and the frequency with which business is conducted over these devices, a large number of business contacts are made over the devices. Consequently, a business person is often not in the physical presence of his new contact (customer or client) and thus, when conducting business via a wireless communication device, the business person is unable to immediately present a business card to the contact. Therefore, the business person has to resort to mailing the business card to the contact or providing his contact information verbally over the communication devices. This mode of establishing new business contacts is not desirable, since it involves extra steps to get the business card to the contact and/or forces the contact to have to write the information down on a sheet of paper. Additionally, since the first impression is the one which ultimately determines if the potential customer or client in fact becomes a customer/client, providing that professionally done business go card with all required contact information goes a long way in appealing to the sense of professionalism.

With present wireless communication device design, caller ID information is provided to a call recipient when a call is received on the recipient's device. The identified number may then be stored on the recipient's device. However, this information is often limited to the caller's number, and the caller's name is often not provided for the recipient to recognize this number for later contact, the call recipient has to manually enter the remaining data that may be relevant, such as the caller's name and address, etc. Further, it is usually the person from whom the contact originates, who wishes the recipient to have the information readily available for a later contact.

Generally, business cards contain information pertaining to an individual who is normally associated with a business entity. The information on business cards typically includes a company name, an individual's name, title, phone number, facsimile number, mail address, and email address. Business cards thus record the information that is needed to not only identify but also contact the individuals represented by the business cards.

One problem with conventional approaches to distributing or exchanging business cards is that the information on the business cards often becomes outdated after their distribution. Typically, business cards become outdated when the individuals move offices, change employers, obtain promotions, etc. When the information on a particular business card does become outdated, the information no longer facilitates the contacting of the individual associated with the particular business card. The outdated information is often misleading. In general, the persons receiving the business cards cannot determine from the business cards whether the information on the business cards is still accurate.

Another problem with conventional business cards is that their distribution is manual. As a result, for one's business card to be distributed, the business card needs to be physically handed to another person. Also, when a revised business card with updated information is to be distributed, often there is no way to know who currently holds an older version of the business card. As a result, inaccurate business cards remain in circulation long after being outdated.

In summary, current business cards don't work remotely, current business cards require physical inventory of those cards, current business cards become quickly outdated and there is no way to automatically update the contact information that has previously been given, current business cards require tedious and error-prone data entry, and current business card “containers” don't keep records of to whom business cards were given, which version of the cards were given, and when they were given. Thus, there is a need for improved approaches to automatically distribute and update contact information, especially leveraging ubiquitous and universal wireless communication device technologies.

### SUMMARY

The present invention provides a new and improved method of distributing electronic business. In certain embodiments, electronic business cards may be presented or exchanged by registering a user, wherein as part of the registration, the user provides contact information to a data repository. The user then designates which of the contact information is associated with that user's contact profile. Upon receipt of a text message from the user, the user's contact profile is distributed to a third party's wireless communication device.

The foregoing has outlined rather broadly certain aspects of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 is a block diagram showing a general architecture for deployment of one embodiment of the present invention with a web application connected to an SMS mobile phone network;

FIG. 2 is a flow diagram showing a “Push” business card transfer;

FIG. 3 is a flow diagram showing a “Pull” business card transfer;

FIG. 4 is a flow diagram showing how a user of the system creating a new user, selecting payment plans for the service, creating a new electronic business card record and provisioning the service; and

FIG. 5 is a flow diagram showing how a user logging into a user account and modifying their contact information according to an embodiment of the invention.

### DESCRIPTION OF THE PREFERRED EMBODIMENTS

The present invention is directed to improved methods and systems for electronically presenting and exchanging business cards. The configuration and use of the presently preferred embodiments are discussed in detail below. It should be appreciated, however, that the present invention provides many applicable inventive concepts that can be embodied in a wide variety of contexts other than distribution of business cards over cellular phones. Accordingly, the specific embodiments discussed are merely illustrative of specific ways to make and use the invention, and do not limit the scope of the invention.

In general, the invention pertains to an information distribution and management system. The information distribution and management system includes a browser-based client and a server application that interact to facilitate the controlled exchange of contact information over a network. The client-facing application can provide creation and design, rolodex, exchange, and update features. The information management and distribution system can also include a corporate administrator application. The information management and distribution system can also synchronize its central database with personal information management (PIM) or contact management software.

In one embodiment of the present invention, contact information is electronically distributed over a network in a controlled manner. The contact information may include information that is useful for identifying or contacting a registered user, wherein a user may be an individual person, an entity, the members of a group, etc. As an example, the contact information for a registrant may include, among other things, name, telephone number, facsimile number, mail address, and email address. When the registration pertains to a business, the contact information may also include a title, business name, and a universal resource locator (URL) to an associated business website. A registered user that has received contact information pertaining to another registered user can contact the registered user using the contact information.

In another embodiment, previously distributed contact information is automatically updated since contact information is dynamic and needs to be updated and maintained. Hence, should the contact information change after its distribution to certain registered users, the updated contact information is distributed to the registered users in an automated manner.

It will be appreciated by those skilled in the art that contact information can be distributed to registered users in a standardized format. A standardized format for the distributed contact information may be used to facilitate a consistent type of contact information as well as a consistent presentation of the contact information to registered users. In one example, the standardized format is a standard business card arrangement. Further, the standardized format facilitates the association or attachment of additional information to the basic contact information. This additional information can include a wide variety of items. For example, the additional information can include text, data, hyper links, audio objects, video objects, etc. The additional information can also be used for a variety of purposes, including announcements, messages, notifications, and advertisements.

Various embodiments of the invention may include corporate administration. The corporate administrator application enables an administrator to control the use of corporate information. The corporate administrator application can include many of the features associated with the client-side application, including creation and design, rolodex, exchange, and update features. For example, the administrator may wish to update the corporate information that has been previously distributed or exchanged. In addition, the corporate administrator application may facilitate registration of employees of a business entity with the information management and distribution system. The corporate administrator application may also disable certain employees from further use of the corporate information.

The present invention includes a method of presenting and distributing electronic business cards, an apparatus for presenting and distributing electronic business cards, a computer readable medium on which electronic business cards are presented and distributed, and a computer system for presenting and distributing electronic business cards.

As a computer-implemented method for creating and exchanging information over a network, one embodiment of invention includes at least the acts of: registering a plurality of users, each of the users providing a contact profile that is stored in a data repository; permitting the users to associate one or more contact details to their contact profiles; and permitting controlled exchange of the contact profiles and any of the associated contact details between the users through the network.

As a computer readable medium including at least computer program code for creating and exchanging information over a network, one embodiment of the invention includes at least: computer program code for registering a plurality of users, each of the users providing a contact profile that is stored in a data repository; computer program code for permitting the users to associate one or more contact details to their contact profiles; and computer program code for permitting controlled exchange of the contact profiles and any of the associated contact details between the users through the network.

In an information management and exchange system having a plurality of registered users with each user having their own profile information, a method for controlling usability of previously received profile information for a registered user according to one embodiment of the invention includes the acts of: selecting one of the registered users to be disabled; identifying those of the registered users who have previously received profile information from the selected registered user; and disabling use of the profile information for the selected registered user by those of the registered users whom have previously received the profile information from the selected registered user.

The method of the present invention for providing an electronic business card to a contact via a cellular network may be implemented by using a specific software on a wireless device, such as the Apple iPhone. Several business card menu options are provided to a user of the wireless device. The user enters business card information/data into the wireless device utilizing the business card menu options and wireless device keypad. The business card data is stored locally on the wireless device or in a database maintained by the service provider. When the user is in communication via the wireless device with someone to whom the user wishes to provide his business card, the user selects a menu item that activates the transmission of the electronic business card to the desired recipient's wireless device. The message format for the data interchange may be proprietary, or it may be any one of a number of open formats, such as the vCard format.

When the desired recipient has received the business card, an alert is provided to the recipient, who may then save the card on his wireless device or at the service provider's database, if available. The user is thus able to directly provide his business card to the recipient without being in physical presence of the recipient. In one embodiment, the recipient may actually transmit an electronic request for the business card and the user responds to the request by transmitting the card.

Once the data of a business card is stored, the user/recipient is able to access the card data and/or initiate a call to the phone number on the card as a selectable menu option. In wireless devices having email capability, the user may also create and transmit an email to the email address located on the electronic business card as a selectable menu option.

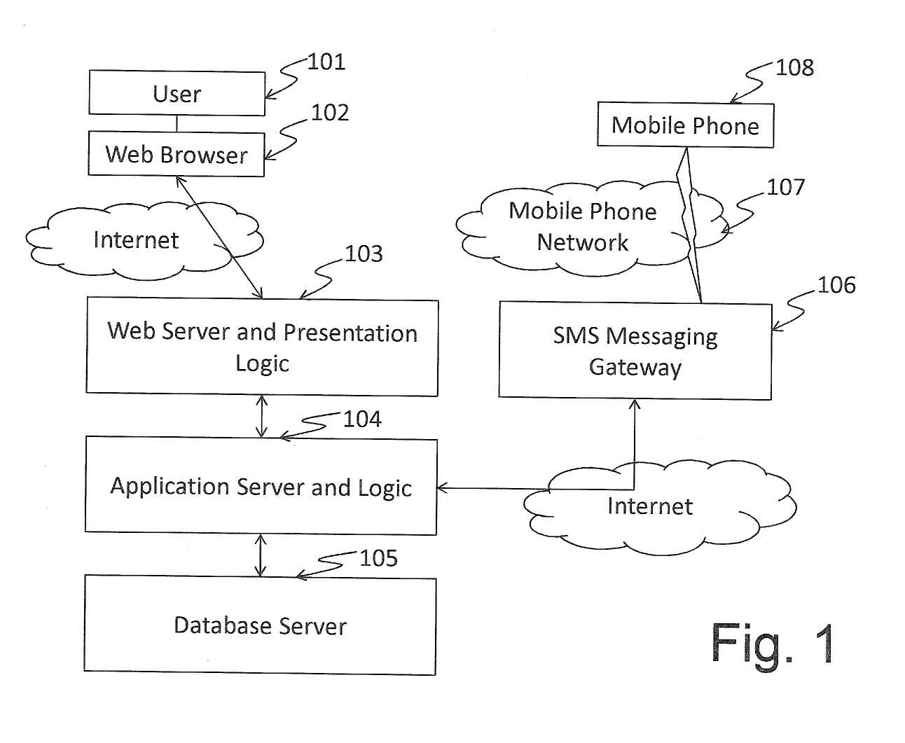

In some cases, the two users do not use the same type of wireless device, and hence must rely on features that nearly all wireless devices support, such as standard SMS messaging, synchronizing with personal-computer based contact managers, or the wireless devices ability to import vCard e-mail attachments directly into the device's contact manager. Referring now to FIG. 1 which show the general system architecture used in one embodiment of the invention. A user 101 utilizes a web browser 102 to access a web server and presentation logic application 103 over the Internet. The web server and presentation logic application 103 is communicatively coupled to an application server and logic application 104. The application server and logic application 104 is also communicatively coupled to a database server 105. Application server and logic application 104 is accessible via the Internet through an SMS messaging gateway 106 and the SMS messaging gateway 106 may be utilized by a mobile phone 108 or other wireless communication device over a mobile phone network 107.

The system can be configured as a flexible command response hub that autonomously and under programmatic control receives, responds to and sends SMS messages. Preferentially, but not exclusively, the application logic is activated by the keyword of an inbound message, and the rest of the message data is passed as an argument. This architecture then provides for a very flexible server remote control via SMS with an arbitrarily complex syntax and defined set of functionality.

In one embodiment, a user of an electronic business card service described herein has an account with a business card exchange service provider, has registered with an associate phone number, and an optional keyword. A service provider will typically be accessible through an SMS “short code.” In the United States, this is a 5-digit number that can be used to send messages to the service provider.

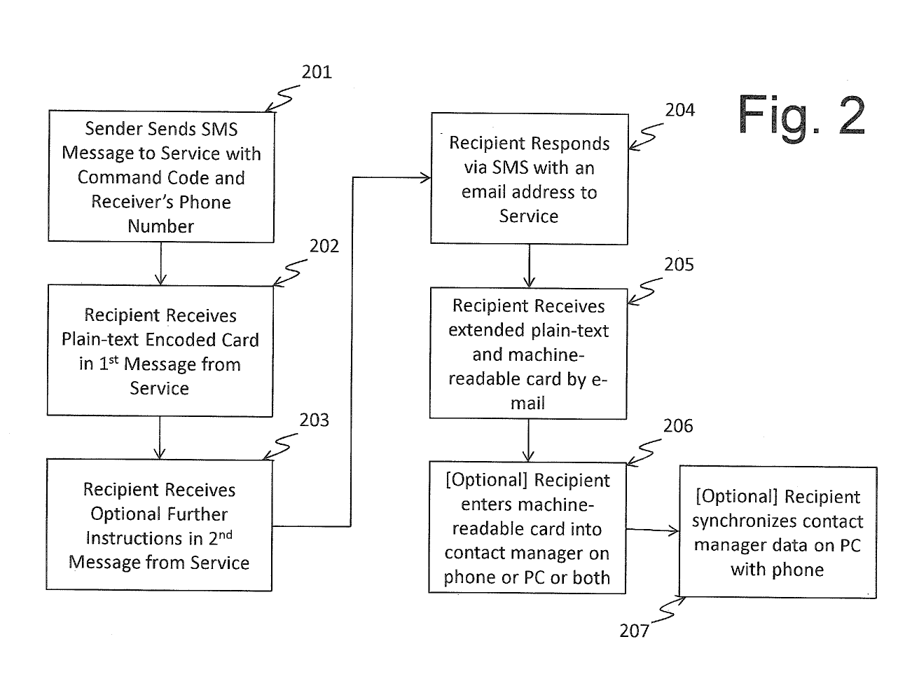

Referring now to FIG. 2 in which a user, “Mike” to be a user of the electronic business card exchange service, and to want to send his contact information to a potential client, “Jim.” Mike would send an SMS message, or “text,” the electronic business card service provider with which he is already registered with a command 201 to forward his information to Jim, by including Jim's phone number. For example, Mike would enter and send an SMS message similar to this:
a. To: 12345
Msg: vCard 5125551212

Where 12345 is the “short code” for his business card exchange service, and 512-555-1212 is Jim's phone number, which may have been given to Mike verbally.

The electronic business card exchange service will send an SMS message 202 to Jim's device containing a human-readable plain-text set of information that Jim can read or store.

Further, the service will optionally send Jim an incremental message 203 with more information, which may be instructions to send the system to register Jim himself or to pull Mike's contact information in machine readable for by use of a wireless device-based web-browser or to request it be sent by e-mail. Jim would reply 204 to this second message with, for example, his e-mail address—and the business card exchange service would send him Mike's contact information in machine-readable format.

Jim would them be able to open this e-mail from his wireless device directly and import the information sent him in machine readable format directly into a contact manager on the device itself 206. Alternatively Jim could open that e-mail from a PC, import Mike's contact information into a desktop contact manager and synchronize with his device 207.

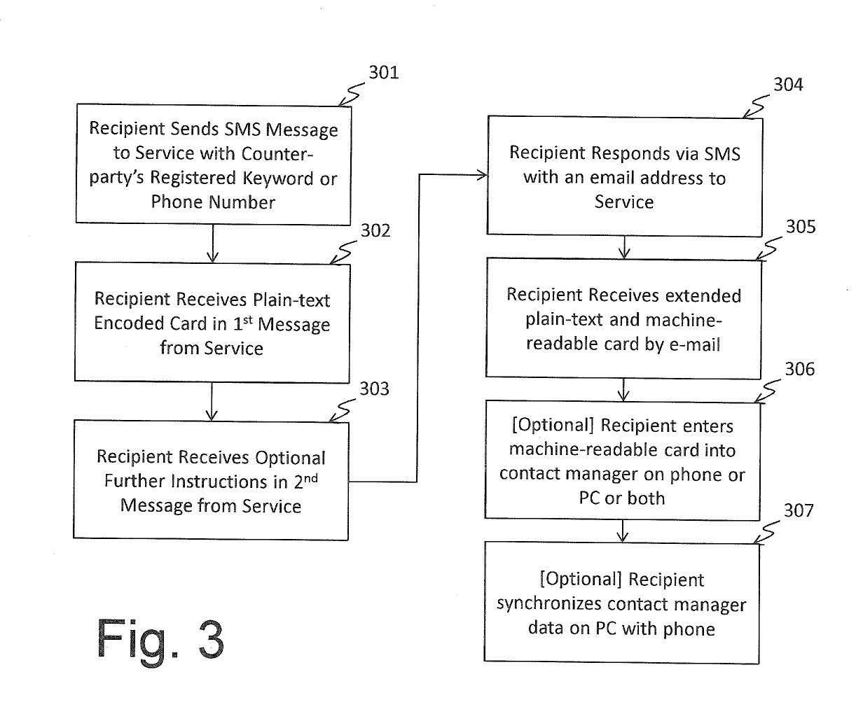

Referring now to FIG. 3 in which Jim wishes to “pull” Mike's contact information. Mike will be a registered user of the service, and have a phone number of record—and possibly a keyword registered as well. Mike could tell Jim to “text ‘Mike’ to 12345”, where ‘Mike’ is Mike's registered keyword, and 12345 is the short-code of the business card exchange service. Jim would send 301 the SMS message:
a. To: 12345
   Msg: Mike

The system would then transmit Mike's plain text contact information to Jim, as above, and the system would flow from there in the same way as depicted in FIG. 2.

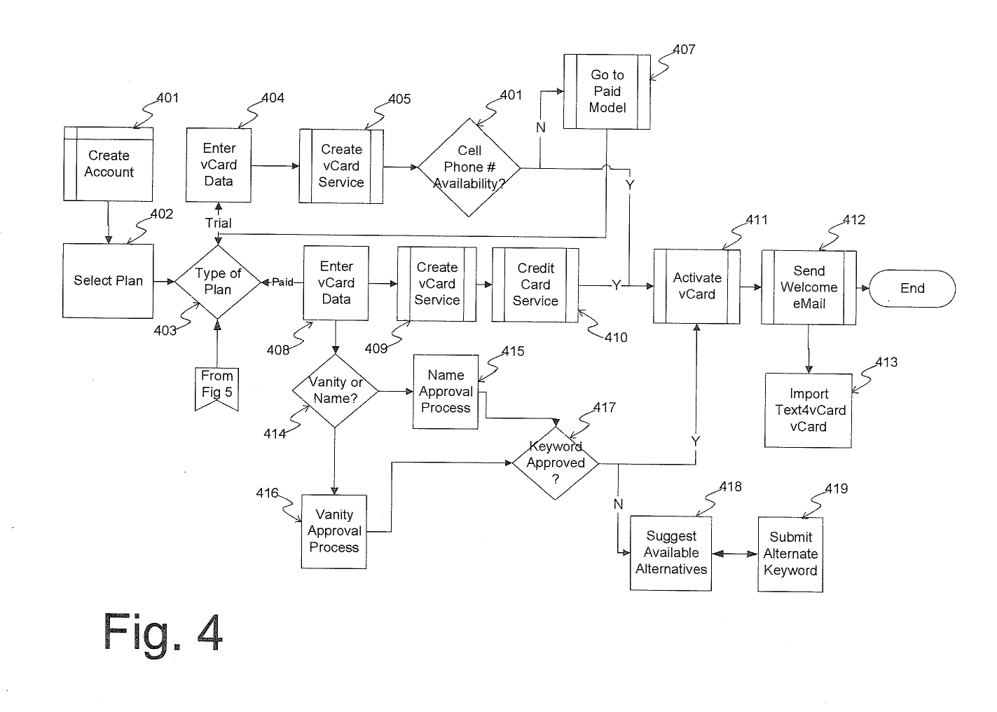

Referring now to FIG. 4 which diagrammatically depicts the creation of a new electronic business card in one embodiment of the invention. A user will create an account 401 and select a plan 402 and the determination of the plan 403 will determine whether it is a trial or paid plan. In connection with a trial plan, the user will enter v-card data 404, create v-card services 405 and, depending on the availability of the cell phone number 406 will go to a paid model 407 or continue to activate the v-card 411. If the plan is a paid plan, the user will enter v-card data 408, create v-card service 409 and create a credit card service 410 and thereafter activate the v-card 411 at which point the system will send a welcome email 412 and optionally import the v-card 413.

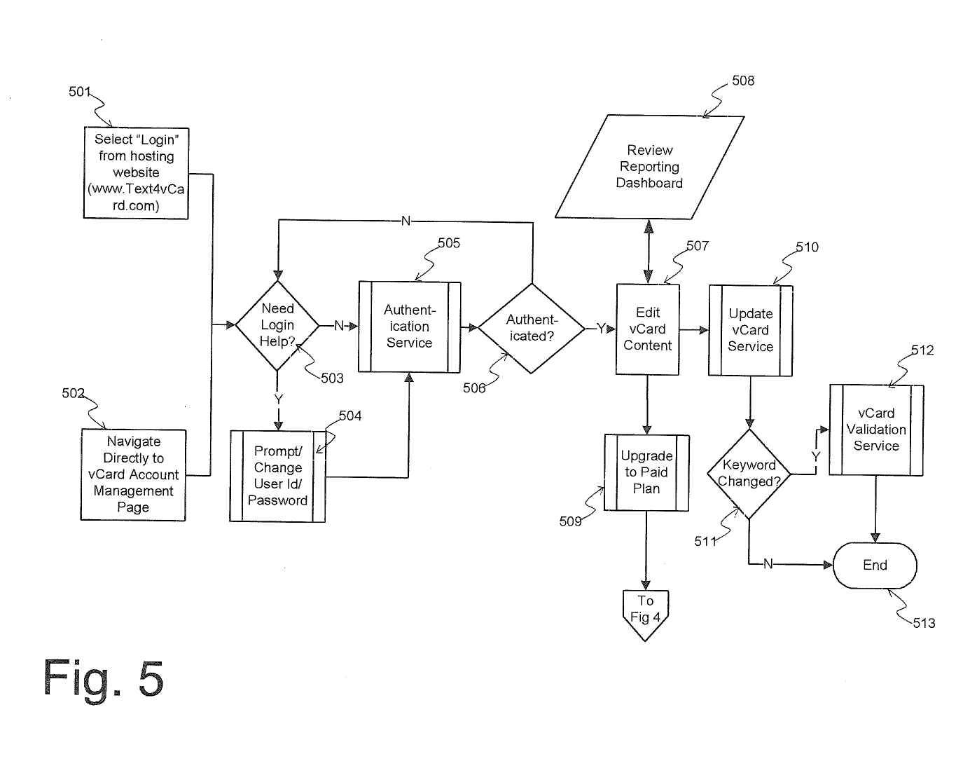

Referring now to FIG. 5 which diagrammatically depicts the update and maintenance of an electronic business card in one embodiment of the invention. To update a v-card record the user will select login from the appropriate site 501 or navigate directly from the v-card account management page 502 and depending upon whether the user needs assistance with login 503 a prompt will occur 504 to change the user ID or password or the user will admitted to the authentication service 505. Once authenticated 506 the user may edit v-card content 507 and may upgrade to a paid plan 509 or update v-card service 510 and optionally change the user's key word 511.

In certain embodiments, the business card exchange service stores information regarding the members who have exchanged information with other members, and could thus update everyone connected to any member whose contact information had changed. This update can occur within the central database, be made available by synchronization to a PC or direct messaging to phone depending upon member's preferences.

SMS messages are typically very short (160 characters), but, in some cases, a certain number of characters can be reserved for the use of the business card exchange service itself, and may be used for any purpose by the service. For example, one purpose might be the sale of that space to create an advertiser supported business card exchange service. Another purpose might be to enroll new business card recipients into the business card exchange system. Another purpose might be to embed promo codes that can be used at stores, by individuals that have received someone's business card. Other purposes may also be advanced by those skilled in the art.

Because SMS messages are very short, it will be sometimes necessary to send a second message to the business card recipient to provide instructions to complete the ‘exchange’ of full information. In one embodiment, the second message may embed hooks, or pointers or URLs to multi-media objects that can be retrieved and viewed or played by a multi-media device.

In addition, because SMS messaging protocol is very generic, the message interchange flow described can trivially be extended to support a number of other applications. These include, but are not limited to: calendaring; appointment slips; membership cards; frequent buyer cards and discount coupons.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of communication devices available, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

We claim:

1. A method for exchanging electronic business cards comprising:
registering a user, wherein as part of said registration, said user provides contact information that is stored in a data repository;
allowing a user to designate which of said contact information is associated with said user's contact profile;
upon receipt of a text message from said user, distributing said contact profile of said user to a wireless communication device of a third party designated by said user in said text message.

2. The method of claim 1 wherein said text message is a short code.

3. The method of claim 1 wherein said user is notified that said contact profile has been distributed to said third party.

4. The method of claim 1 wherein said contact profile, when distributed to said third party, further includes advertisements of interest to said third party.

5. The method of claim 1 wherein said contact profile, when distributed to said third party, further includes the ability for said third party to request additional contact information from said user.

6. The method of claim 1 wherein said contact profile, when distributed to said third party, further allows said user to forward said contact profile to an email address designated by said third party.

7. The method of claim 1 wherein said user is required to include a keyword in said text message when requesting that said contact profile be distributed to said third party.

8. The method of claim 1 wherein said third party is notified of a future change to said contract profile of said user.

9. A method for exchanging electronic business cards comprising:
registering a user, wherein as part of said registration, said user provides contact information that is stored in a data repository;
allowing a user to designate which of said contact information is associated with said user's contact profile;
upon receipt of a text message from a third party, distributing said contact profile of said user to a wireless communication device of said third party.

10. The method of claim 9 wherein said text message is a short code.

11. The method of claim 9 wherein said user is notified that said contact profile has been distributed to said third party.

12. The method of claim 9 wherein said said contact profile, when distributed to said third party, further includes advertisements of interest to said third party.

13. The method of claim 9 wherein said contact profile, when distributed to said third party, further includes the ability for said third party to request additional contact information from said user.

14. The method of claim 9 wherein said contact profile, when distributed to said third party, further allows said third party to forward said contact profile to an email address designated by said third party.

15. The method of claim 9 wherein said third party is required to include a keyword in said text message when requesting that said contact profile be distributed to said third party.

16. The method of claim 9 wherein said third party is notified of a future change to said contract profile of said user.

17. A system for the distribution of electronic business cards comprising:
a database containing a user's contact information, wherein said user can designate which of said contact information is included in said user's contact profile;
a wireless communication device registered to a third party; wherein, upon receipt of a text message from said user designating said wireless communication device, said user's contact profile is distributed to said wireless communication device.

18. The system of claim 17 wherein said text message is a short code.

19. The system of claim 17 wherein said user is notified that said contact profile has been distributed to said third party.

20. The system of claim 17 wherein said contact profile, when distributed to said third party, further includes advertisements of interest to said third party.

21. The system of claim 17 wherein said contact profile, when distributed to said third party, further includes the ability for said third party to request additional contact information from said user.

22. The system of claim 17 wherein said contact profile, when distributed to said third party, further allows said user to forward said text message to an email address designated by said third party.

23. The system of claim 17 wherein said user is required to include a keyword in said text message when requesting that said contact profile be distributed to said third party.

24. The system of claim 17 wherein said third party is notified of a future change to said contract profile of said user.
